(19) United States
(12) Patent Application Publication
(10) Pub. No.: US 2007/0115925 A1
(43) Pub. Date: May 24, 2007

(54) Group calling method and system

(76) Inventor: Marc J. Sachnoff, Los Angeles, CA (US)

Correspondence Address: Sachnoff & Weaver, Ltd., 10 S. Wacker Drive, Chicago, IL, 60606-7507, US

(21) Appl. No.: 11/256,412

(22) Filed: Oct. 21, 2005

(51) Int. Cl. H04L 12/66

(52) U.S. Cl. 370/352

(57) ABSTRACT

One or more communications devices in communication forming a calling group. A server associated with the communications devices transmits information to the individual members of the calling group. For example, an incoming information transmission is received from a communications device. The incoming information transmission is recorded in a memory of a server. The incoming information transmission is transmitted to the individual communications devices of the members of a predetermined calling group.

### BACKGROUND

1. Technical Field

This invention relates a system and method for initializing a calling group and recording a message and calling and relaying the recorded message to the other calling group members.

2. Description of the Related Arts

There are conference calling systems in the art. For example, there are methods of initializing conference calls between users of Radio Frequency handsets (e.g., “walkie-talkies”). There are also methods for setting up conference calls for multiple phone users. In each of these methods, all users can listen in at the same time on the conference call—i.e., a user talking is simultaneously heard by multiple recipients of the group. In such systems/methods, a single group member can simultaneously broadcast a message to all of the group members at once. However, such methods/systems do not allow for a message to be rebroadcast to group members who are not participants in the conference call at the time the message is generated by one of the group members participating in the conference call or broadcasting the message. Accordingly, group members who are not listening in on the conference call might miss hearing an important message.

Moreover, in the current systems it is relatively complex to set up a calling group. For example, the name and phone number of each group member often has to be manually entered into the phone system on which the conference call is set up. In other systems, each of the group members has to call into a specific phone number to participate in the conference call or tune a wireless handset to a specific frequency to listen to the call/message being broadcast.

### SUMMARY OF THE INVENTION

Embodiments of the inventions are directed to a method and a server that transmits information to a calling group. An incoming information transmission is received from a communications device. The incoming information transmission is recorded in a memory of a server. The incoming information transmission is transmitted to the individual communications devices of the members of a predetermined calling group.

Additional embodiments are directed to a communications device having a communications port to establish a communications link with a second communications device. A memory stores phone numbers of communications devices in a predetermined calling group. Circuitry establishes a link to a call server and transmits information which is recorded at the call server. The information includes the phone numbers. After the information is recorded, part of the information is transmitted to the individual communications devices of the members of the calling group.

### BRIEF DESCRIPTION OF THE DRAWINGS

FIG. 1 illustrates a cell phone according to an embodiment of the invention;

FIG. 2 illustrates the group calling system according to an embodiment of the invention;

FIGS. 3A and 3B illustrate group initialization methods according to embodiments of the invention;

FIG. 4 illustrates a method of group calling according to an embodiment of the invention;

FIG. 5A illustrates a method of setting up a group with a cell phone having an IR port according to an embodiment of the invention; and

FIG. 5B illustrates a method of setting up a group with a cell phone having a hard-wired communications port according to an embodiment of the invention.

FIG. 5C illustrates a method of defining a group on a communications device such as a cell phone.

### DETAILED DESCRIPTION

An embodiment of the invention is directed to a group calling method and system. In an exemplary system, a number of users of portable communication devices such as, e.g., cellular phones, personal data assistants, handheld computers or other similar communication devices, may form a calling group. A calling group is a predetermined group of dynamically added group members that form a mini network. Alternatively, the calling group may be configured to include multiple mini networks. For example, all teachers at a high school may be a calling group. Any of the group members may call a designated phone number and record a voice message on a communications server, wherein the communications server may be a telephone server. The communications server may then implement a routine, establishing a communications link with each group member and transmitting the message. For example, in the event a high school principal and all of the high school teachers form the calling group, the principal may call the designated number and record a voice message on the communications server to inform the group members that school has been cancelled for that day. The communications server may then establish a communications link with each of the group members, for example, by telephoning each group member and audibly replaying the recorded voice message. The message may be digitally recorded and copies may be made so that multiple group members can be called simultaneously or individually and the message may be replayed.

An embodiment of the invention also provides for a simple method of initializing the group. For example, the cell phones of each of the group members may contain an Infra Red (“IR”) port, a serial port, or any other suitable communications port/pathway. To initialize a group, each of the group members may couple his or her cell phone with each of the other group members' cell phones, and the respective cell phone numbers (and the group members' names, in some embodiments) may be exchanged. Alternatively, communication may be set up between each group member's cell phone and a master cell phone, whereby information for each group member's cell phone is transmitted to the master cell phone. Once the master cell phone has information for each of the group members, communication may again be established between the master cell phone and each group member's cell phone so that the master may transmit the entire group list to each of the group members. In some embodiments, the master cell phone may also communicate the information for the group list to the communications server.

When one of the group members decides to call the dedicated group phone number and leave a message on the communications server, the user's phone may transmit the information about the other group members to the communications server while the user is leaving the voice recording. In other embodiments, the group calling information is already stored on the communications server and need not be transmitted thereto when one of the group members calls the communications server. After the user has finished leaving the message, the communications server may then call each of the group members and play the recorded message. Accordingly, sending messages to multiple users may be achieved without all the users having to simultaneously participate in a conference call. One of skill in the art will appreciate that, beyond transmission of voice and text data, other forms of digital data may be transmitted.

If one of the group members is not available (e.g., the user's cell phone is busy and/or a voicemail or page cannot be left for the user), the telephone server may try calling the unavailable group member later. Each, or some, of the cell phones of the group members may include a special “group calling” button, which may be pressed when the user wishes to leave the voice message to be replayed, instead of having to manually enter the dedicated communications server phone number.

Communications devices are not limited to cellular phones, but may include Personal Digital Assistants (“PDAs”) or portable computers. In other embodiments, communications devices other than cell phones may also be utilized. For instance, a call device configured as a transmitter, receiver, or a combination thereof may be utilized. The call device need not employ both a display and keypad, but may employ only one or the other. The call device may even employ neither a display or a keypad. For example, a call device may be a transceiver with a light and a single button. Other embodiments may further include a message delivery status notification (hereinafter, “report back”) in which delivery status information is immediately returned to an initiator. Report back notifications may include, without limitation, “message received,” “busy,” “device off,” “out of network,” or the like. One of skill in the art will appreciate that any means of wireless communication may be used, such as but not limited to CDMA, GSM, GPRS, internet protocols, the SMS space, GPS or similar technologies.

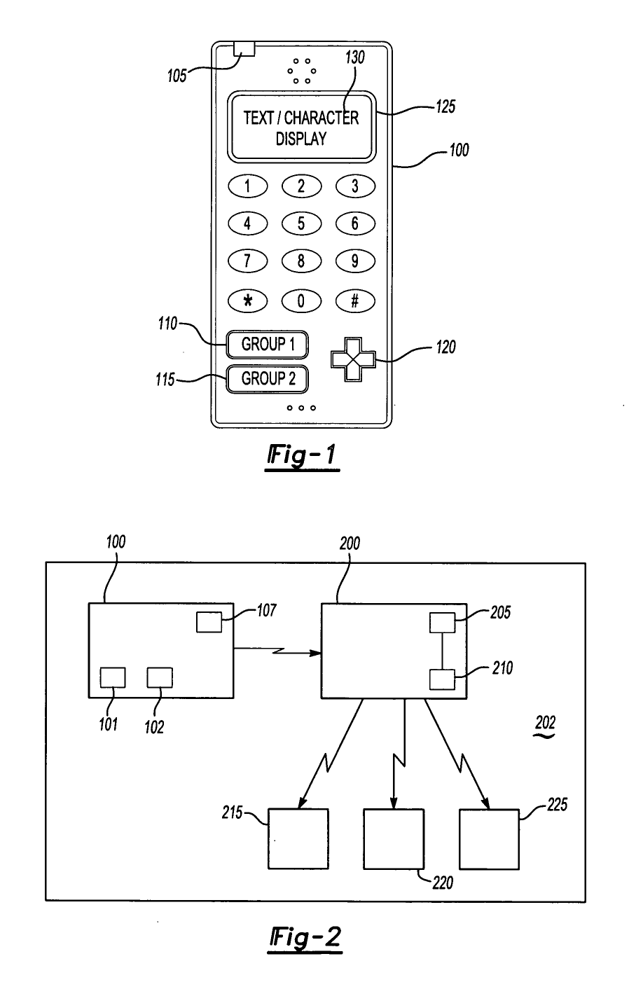

FIG. 1 illustrates a cell phone 100 according to an embodiment of the invention. The cell phone 100 may be an ordinary cell phone, or it may be a customized cell phone having special group calling buttons 110 and 115. As shown, the cell phone may include a communications port 105. The communications port 105 may be an IR port, a serial cable port, or any other suitable type of communications port. The cell phone 100 may also include a customized button 110 for “Group 1,” which the user may press to leave a message to be audibly replayed to all group members of Group 1. The cell phone 100 may also include a customized button 115 for “Group 2,” which the user may press to leave a message to be replayed to all group members of Group 2. Although shown at the bottom of the cell phone 100, the “Group 1” and “Group 2” buttons 110 and 115 may be located anywhere on the cell phone 100. In other embodiments, more or fewer than two group call buttons 110 and 115 may be utilized. In other embodiments, the cell phone may not have a group call button, and the user may call the communications server by manually dialing the group phone number. Still in other embodiments, a multi-directional scroller 120, such as a miniaturized joystick or a rocker button, may be utilized instead of or in combination with “Group 1” or “Group 2” buttons 110 and 115 to allow a user to scroll through a programmable relational database of records, stored in memory 101 of the cell phone 100. This “Group List” 130, which appears in display 125, may be dynamically edited by the user to add or delete groups as practically necessary.

FIG. 2 illustrates the group calling system 202 according to an embodiment of the invention. As shown, the system includes the cell phone 100 and a communications server 200. For illustrative purposes, the communications server is described in this example as a telephone server and includes a memory 205 and a processor 210.

To send a group message, the user cell phone 100 may call the group phone number and leave a voice message on the communications server 200. When the phone call is made to the communications server 200, a list of data relating to the calling group (e.g., the phone numbers of all of the group members) may be simultaneously transmitted to the communications server 200. The data relating to the calling group may then be stored in the memory 205, as well as the recorded voice message. After the message has been recorded, the communications server 200 may call the cell phones 215, 220, and 225 for the group members and audibly replay the recorded voice message. A processor 210 within the communications server 200 may execute program code stored in the memory 205 to implement the telephone calling application.

In the event that nobody answers a cell phone for a group member when the communications server 200 calls the group member, the communications server 200 may either leave a message on the group member's voicemail and/or call back in an attempt to reach the group member after a predetermined time delay. In addition, the report back feature of the present invention, described above, may be employed in the event a call is not answered. In other embodiments, the communication devices described above as cell phones 215, 220, and 225 may be electronic communication devices such as PDAs, computers, pagers or hard-wired telephones.

In other embodiments, the communications server 200 may record the voice message, convert it into a voice file, and then transmit the voice file to the group members. In such embodiments, the group members could utilize notebook computers to receive the voice files and could even receive the voice files via email. One of skill in the art will appreciate that not only voice files but also text, photos, music, or other digital data may be similarly transmitted.

In other embodiments, the communications server 200 may contain a list of the phone numbers of all of the group members, and the cell phone 100 may not need to transmit these phone numbers to the communications server 200.

The cell phone 100 may include a memory 101 to store the phone numbers of the calling group and a processor 102 to execute program code stored in the memory 101 to transmit the phone numbers to the communications server 200 via circuitry 107.

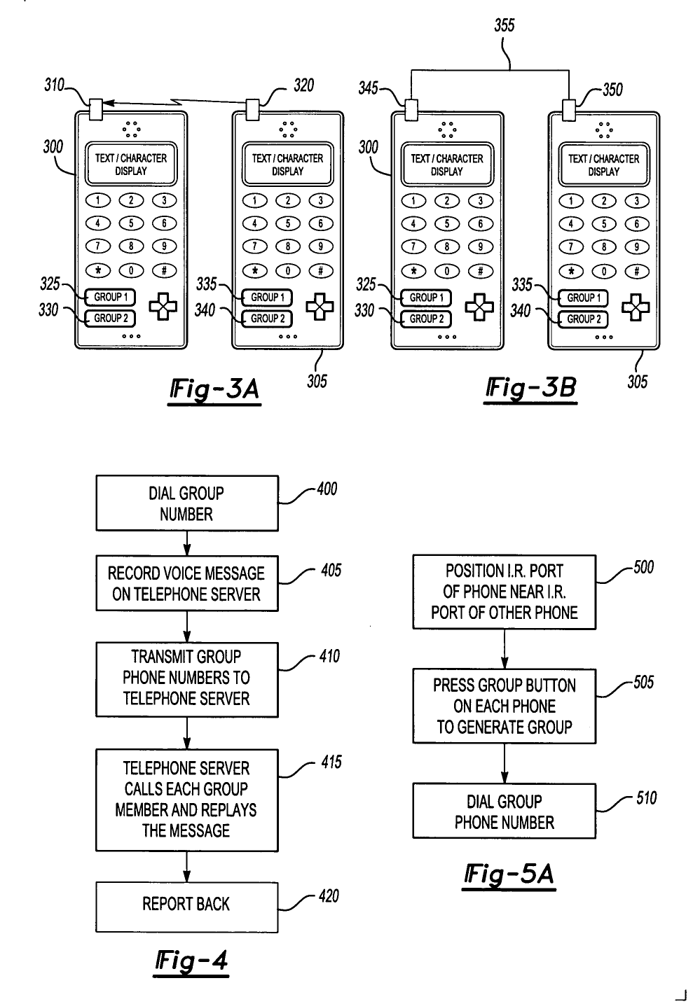

FIGS. 3A and 3B illustrate group initialization methods according to embodiments of the invention. As shown in FIG. 3A, two cell phones 300 and 305 may be utilized to initialize a calling group. Cell phone 300 may include an IR port 310, a “Group 1” calling button 325, and a “Group 2” calling button 330. Cell phone 305 may include an IR port 320, a “Group 1” calling button 335, and a “Group 2” calling button 340. To initialize both cell phones 300 and 305 so that each becomes a group member of “Group 1,” the cell phones 300 and 305 may be placed near each other so that their respective IR ports 310 and 320 are in optical alignment. One of skill in the art will appreciate that instead of an IR port 320, any other hardware supporting wireless communication functionality may be used. Such hardware may support for example, satellite, microwave or RF wireless communication technologies and combinations thereof. RF communications technologies include WiFi and WiMax.

To continue group initialization, a user may then depress the “Group 1” buttons 325 and 335 on each of the cell phones 300 and 305, and data relating to each respective cell phone's cell phone number and identity may be transmitted via IR to the other phone. The same process may be repeated by depressing the respective “Group 2” buttons 330 and 340 to add each cell phone 300 and 305 to the “Group 2” calling group. One of skill in the art will appreciate that the multi-directional scroller 120 may be utilized to navigate through and select a pre-programmed group from the “Group Lists” 130.

FIG. 3B illustrates two cell phones 300 and 305 which may also be utilized to initialize a calling group. Cell phone 300 may include a communications port 345, a “Group 1” calling button 325, and a “Group 2” calling button 330. Cell phone 305 may include a communications port 350, a “Group 1” calling button 335, and a “Group 2” calling button 340. To initialize both cell phones 300 and 305 so that each becomes a group member of “Group 1,” the cell phones 300 and 305 may be placed near each other, and a cable 355 may be coupled to the communications ports 345 and 350 to provide for the transfer of data. A user may then depress the “Group 1” buttons 325 and 335 on each of the cell phones 300 and 305, and data relating to each respective cell phone's cell phone number and identity may be transmitted via the cable 355 to the other phone. The same process may be repeated by depressing the respective “Group 2” buttons 330 and 340 to add each cell phone 300 and 305 to the “Group 2” calling group.

FIG. 4 illustrates a method of group calling according to an embodiment of the invention. First, a user of a cell phone 100 may dial 400 a group phone number. Next, the user may leave 405 a voice message on a communications server 200 associated with the group phone number. While the user is leaving 405 the voice message, or shortly thereafter, the user's cell phone 100 may transmit 410 the phone numbers of the group members to the communications server 200. After the user has finished leaving 405 the voice message on the communications server 200, the communications server 200 may call 415 each group member and replay the recorded message. Thereafter, the communications server 200 may report back 420 to the user of the cell phone 100 with any number of notifications, such as “message received,” “busy,” “device off,” “out of network,” or the like.

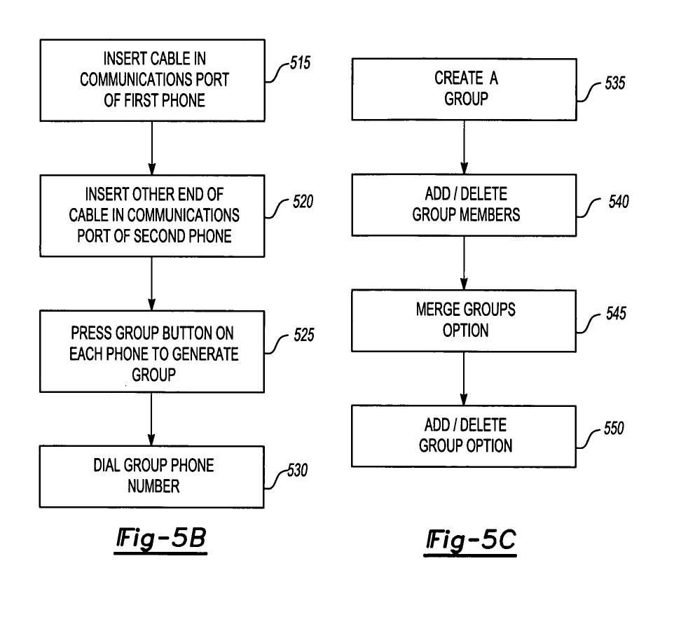

FIG. 5A illustrates a method of setting up a group with a cell phone 300 having an IR port 310 according to an embodiment of the invention. First, the user positions 500 the IR port 310 of the first cell phone 300 near the IR port 320 of a second cell phone 305, as shown in FIG. 3A. Next, the user presses 505 a group button (e.g., “Group 1” button 110 or “Group 2” button 115) on each of the cell phones 300 and 305 to initiate the IR transmission of the identity and phone number of each respective cell phone to the other cell phone. Finally, the user may dial 510 the group phone number and leave a message, as illustrated in FIG. 4.

FIG. 5B illustrates a method of setting up a group with a cell phone 300 having a hard-wired communications port 345 according to an embodiment of the invention. First, the user inserts 515 one end of a cable 355 into the communications port 345 of the first cell phone 300, as shown in FIG. 3B. Next, the user inserts 520 the other end of the cable 355 into the communications port 350 of the second cell phone 305. The user then presses 525 a group button (e.g., “Group 1” button 110 or “Group 2” button 115) on each of the cell phones 300 and 305 to initiate the transmission of the identity and phone number of each respective cell phone to the other cell phone. Finally, the user may dial 530 the group phone number and leave a message, as illustrated in FIG. 4.

In conjunction with FIGS. 1 and 2, FIG. 5C illustrates a method of defining a group on a cell phone 100 having memory 101, a processor 102, circuitry 107, a display 125, a “Group List” 130, and a multi-directional scroller 120 according to an embodiment of the invention. First, the user may create a group 535, thus naming a table for the “Group List” 130. Next, the user may add or delete group members using the add/delete group members 540 function. Next, the user may choose whether or not to merge a pre-existing group into the newly defined group using the merge groups option 545. Finally, the user may add the newly defined group to the “Group List” 130 or elect to delete the newly defined or other pre-existing groups from the “Group List” 130 using the add/delete group option 550.

Although the embodiments described above pertain to cell phones, any other suitable communications device, such as a PDA or a hard-wired telephone, may also be utilized. Also, in other embodiments instead of the user leaving a voice message on the communications server 200, the user may transmit any digital data or file to the communications server 200, which may transmit the file or data to the other group members. The user may also email a voice message to the communications server 200, and the communications server 200 may individually call or otherwise establish communication with the group members and replay or transmit the message.

In additional embodiments, the user may also phone the communications server 200 and leave a voice message, which the communications server 200 may then transmit/email to the other group members. Also, during the initialization process, instead of initializing the group by forming one-to-one connections with the communications device for each group member, a “master communication device” may instead be used. The master communication device may communicate individually with each group member to compile the group list, and then it may transmit the group list to each of the group members.

Embodiments of the invention may be useful in facilitating communication and message delivery between any predefined group of users. The invention may have particular usefulness for the management of a family unit where, for example, it is anticipated that virtually instant and automated broadcast communication in an emergency would be critical. The invention may further be useful for anyone seeking to manage an organization communication system amid management teams. The organization communication system would provide a single member of the organization the ability to transmit voice or data to a large number of colleagues virtually instantly. One of skill in the art will appreciate that the invention is not limited in its use to family unit management or organization communication system management. The invention may also be used by childcare workers, educators, military personnel, medical professionals or any individual or group that desires group communication. Moreover, the initialization process may provide a simple way of setting up a calling group.

While the description above refers to particular embodiments of the present invention, it will be understood that many modifications may be made without departing from the spirit thereof. The accompanying claims are intended to cover such modifications as would fall within the true scope and spirit of an embodiment of the present invention. The presently disclosed embodiments are therefore to be considered in all respects as illustrative and not restrictive, the scope of an embodiment of the invention being indicated by the appended claims, rather than the foregoing description, and all changes which come within the meaning and range of equivalency of the claims are therefore intended to be embraced therein.

Claimed is:

1. A method of a server for transmitting information to a calling group, comprising:
receiving an incoming information transmission from a communications device;
recording the incoming information transmission in a memory of a server; and
transmitting the incoming information transmission to communications devices of a predetermined calling group.

2. The method according to claim 1, wherein the information transmission is a data file.

3. The method according to claim 1, wherein the information transmission is an initiator's voice data sent via a telephone.

4. The method according to claim 1, wherein the communications device is a cell phone.

5. The method according to claim 1, wherein the communications device is a call device.

6. The method according to claim 1, further including receiving a set of phone numbers for the calling group from the communications device while the incoming information is being transmitted.

7. The method according to claim 1, wherein the server individually transmits the information transmission by individually calling the communications devices of the calling group and audibly plays the information transmission.

8. The method according to claim 1, wherein the calling group is initialized for management of a family unit.

9. The method according to claim 1, wherein the calling group is initialized for management of an organization communications system.

10. A method of transmitting a voice message to communications devices of a predetermined calling group, comprising:
receiving an incoming call from a first telephone;
recording a voice message from a user of the first telephone;
calling the communications devices of the calling group; and
audibly playing the voice message.

11. The method according to claim 10, wherein a server receives at least one incoming phone call from a first telephone.

12. The method according to claim 10, further including the step of referencing a group list when calling the communications devices.

13. The method according to claim 10, further including message delivery status notification.

14. The method according to claim 10, further including receiving a set of phone numbers for the calling group from the communications device while the incoming information is being transmitted.

15. A method of initializing a calling group, comprising:
establishing a communications link between a first communications device and a second communications device;
pressing a first preselected button on the first communications device; and
pressing a second preselected button on the second communications device, wherein when both the first preselected button and the second preselected button have been pressed and the communications link has been established, first identity information regarding the first communications device is transmitted from the first communications device to the second communications device, and second identity information regarding the second communications device is transmitted from the second communications device to the first communications device.

16. The method according to claim 15, wherein at least one of the first communications device and the second communications device is a cell phone.

17. The method according to claim 15, wherein at least one of the first communications device and the second communications device is a Personal Digital Assistant.

18. The method according to claim 15, wherein the communications link is established via Infra Red.

19. The method according to claim 15, wherein the communications link is established via a hard-wired connection.

20. The method according to claim 15, wherein the communications link is established via a wireless link comprising at least one wireless communication technology selected from the group consisting of satellite, microwave, RF, and combinations thereof.

21. A communications device, comprising:
a communications port to establish a communications link with a second communications device;
memory to store phone numbers of communications devices in a predetermined calling group; and
circuitry to establish a link to a server and to transmit information, the information being recorded at the server, wherein after the information is recorded part of the information is transmitted to the communications devices of the members of the calling group.

22. The communications device according to claim 21, wherein the information includes a user's spoken voice.

23. The communications device according to claim 21, wherein the communications device includes a data file.

24. The communications device according to claim 21, wherein the communications device includes a cell phone.

25. The communications device according to claim 21, further including a dedicated calling group button.

26. The communications device according to claim 21, further including a multi-directional scroller.

27. A processor-readable medium having encoded thereon a processor-readable program code which when executed causes a processor to implement a method comprising:
receiving an incoming information transmission from a communications device;
recording the incoming information transmission in a memory of a server; and
transmitting the incoming information transmission to communications devices of a calling group.

28. The processor-readable medium according to claim 27, wherein the information transmission is a data file.

29. The processor-readable medium according to claim 27, wherein the information transmission is an initiator's voice data sent via a telephone.

30. The processor-readable medium according to claim 27, wherein the communications device is a cell phone.

31. The processor-readable medium according to claim 27, further including receiving a set of phone numbers for the calling group from the communications device while the incoming information is being transmitted.

32. The processor-readable medium according to claim 27, wherein the server individually transmits the information transmission by individually calling the communications devices of the calling group and audibly plays the information transmission.

33. A family unit kit comprising at least one calling group and at least one server.

34. An organization communication kit comprising at least one calling group and at least one server.

35. A cell phone, comprising:
a communications port to establish a communications link with a second communications device;
memory to store phone numbers of communications devices in a predetermined calling group; and
circuitry to establish a link to a server and to transmit information, the information being recorded at the server, wherein after the information is recorded part of the information is transmitted to the communications devices of the members of the calling group.

36. The cell phone according to claim 35, wherein the information includes a user's spoken voice.

37. The cell phone according to claim 35, wherein the cell phone includes a data file.

38. The cell phone according to claim 35, further including a dedicated calling group button.

39. The cell phone according to claim 35, further including a multi-directional scroller.
